(19) United States
(12) Patent Application Publication
(10) Pub. No.: US 2018/0276950 A1
(43) Pub. Date: Sep. 27, 2018

(54) METHOD OF ADMINISTERING CASINO BACCARAT WITH INDIVIDUAL PLAYER BONUS CARD COMBINATIONS

(71) Applicant: AGS LLC, Las Vegas, NV (US)

(72) Inventors: Ronald A. LaDuca, Millstone, NJ (US); Todd D. Fishon, Henderson, NV (US)

(21) Appl. No.: 15/987,064

(22) Filed: May 23, 2018

Related U.S. Application Data
(63) Continuation-in-part of application No. 15/466,432, filed on Mar. 22, 2017.

(51) Int. Cl. G07F 17/32

(52) U.S. Cl. CPC G07F 17/3293; G07F 17/322; G07F 17/3211; G07F 17/3288; G07F 17/3258; G07F 17/3267; G07F 17/323

(57) ABSTRACT

An individualized progressive system for casino baccarat is disclosed. A method of administering a Baccarat casino card game in combination with an optional bonus bet relative to at least one individual player uniquely assigned ROYAL 9® card combinations of a face card and a nine card of specified suits. Each player position is assigned at least one unique ROYAL 9® card combination that will trigger one or more bonus awards when a matching ROYAL 9® card combination appears in the dealt Banker hand and/or Player hand.

### RELATED APPLICATION DATA

This application is a continuation-in-part of U.S. patent application Ser. No. 15/466,432, filed Mar. 22, 2017. The present application claims priority to said prior application and incorporates by reference said prior application as if set forth fully herein.

### FIELD OF THE INVENTION

The present invention relates to casino card games and in particular to a method for administering a casino Baccarat card game.

### BACKGROUND OF THE INVENTION

In prior art casino Baccarat, the hands dealt are community hands (i.e. every player is making their individual wager based on the same combination of cards: a single player community hand and a single banker community hand). In order to make Baccarat games more exciting, progressive jackpot have been offered. However, prior art progressive Baccarat game wins are triggered by a winning combination that is shared by all players, thus resulting in the progressive jackpot being shared by all players. Prior art progressive Baccarat wagers have not been successful since everyone plays off of the same two community hands, so that the players would have to split the progressive prize.

Other Baccarat progressives have a combination that initiates the progressive jackpot, but the combination is available to every player. When it hits, all the players that made the wager will split the prize.

In the prior art, if every player that makes the progressive wager splits the progressive jackpot when the winning combination is achieved, the value of the wager is decreased. Players are better off playing alone on the table to maximize the value of the wager. The more people playing, the less money each player will win when the jackpot is initiated.

Mathematically in the prior art, when more than one player at a table is making the progressive wager in a shared jackpot using only the shared community cards, the more players that play the shared progressive jackpot at a table diminishes the value of each players wager.

A number of prior art patents show different kinds of progressive bets on cards dealt in the Baccarat game, but all pay out progressive betting players equally since the hands are based strictly upon all players using the same two sets of community cards, the player cards and the banker cards.

An object of the invention is to provide a personalized bonus wagering opportunity for players of Baccarat games, wherein each player has a unique opportunity for a bonus payout.

### SUMMARY OF THE INVENTION

Aspects of the invention comprise methods of presenting and playing games, gaming machines and gaming systems.

One embodiment of the invention comprises a method of presenting or playing a Baccarat game with a bonus opportunity to a plurality of players. The game may be presented at a gaming table and comprise the steps of: a) receiving, relative to each of the plurality of players, a Baccarat wager comprising at least one physical item associated with a monetary value at either a Player hand wagering location, a Banker hand wagering location or a Tie wagering location of a layout of the gaming table; b) receiving, relative to each of the plurality of players, an optional bonus wager comprising at least one physical item associated with a monetary value at a bonus wagering location of the layout of the gaming table; c) associating a single unique bonus hand with each of the plurality of players; d) dealing onto the layout of the gaming table, from at least one deck of 52 physical playing cards, a two card Player hand and a two card Banker hand; e) dealing, none, one or more additional cards from the at least one deck onto the layout to form a final Player hand and a final Banker hand; f) determining a winning outcome of the Baccarat game comprising the final Player hand, the final Banker hand or a Tie; g) paying winnings to each of the plurality of players who placed a Baccarat wager on the winning outcome of the Baccarat game; h) relative to each player who placed a bonus wager, determining an outcome of the bonus wager by comparing the unique bonus hand with at least one of the two card Player and the two card Banker hand; and i) paying winnings to each player who placed a winning bonus wager.

Another embodiment of the invention comprises a gaming machine which is configured to present a game of the invention, preferably a Baccarat game with an associated player bonus opportunity. In one embodiment of the invention, the gaming machine may comprise a monetary funds accepting mechanism for accepting monetary funds in creating a player credit balance; at least one display device; at least one player input device; a memory device; a controller; and machine-readable code stored in the memory device executable by the controller to receive a Baccarat wager and, optionally, a bonus wager, placed by the player from the player credit balance; machine-readable code executable by the controller to cause the controller to cause the at least one display device to display a two card Player hand and a two card Banker hand; machine-readable code executable by the controller to cause the controller to cause the at least one display device to display none or one or more additional cards to form a final Player hand and a final Banker hand based upon one or more Baccarat game rules; machine-readable code executable by the controller to settle the player's Baccarat wager with reference to the final Player hand and/or the final Banker hand; and machine-readable code executable by the controller to settle the player's bonus wager with reference to a bonus hand which is unique to the player relative to any other players of the game and the two card Player hand and/or the two card Banker hand.

In one embodiment, a player's bonus wager is winning: a) when the two card Banker hand or two card Player hand comprises the player's bonus hand; b) when the two card Banker hand or the two card Player hand comprises the player's bonus hand and the other hand comprises of a Baccarat natural hand; c) when the two card Banker hand or the two card Player hand comprises the player's bonus hand and the other hand comprises any other King-9 combination; and d) when the two card Banker hand and the two card Player hand comprises the player's bonus hand.

In one embodiment, a) first winnings are awarded to the player when the two card Banker hand or two card Player hand comprises the player's bonus hand; b) second winning are awarded to the player when the two card Banker hand or the two card Player hand comprises the player's bonus hand and the other hand comprises of a Baccarat natural hand; c) third winnings are awarded to the player when the two card Banker hand or the two card Player hand comprises the player's bonus hand and the other hand comprises any other King-9 combination; and d) fourth winnings are awarded to the player when the two card Banker hand and the two card Player hand comprises the player's bonus hand.

In one embodiment, a single unique bonus hand is assigned to or is selected by a player, which hand is unique to all other players of that game. In other embodiments, more than one bonus hand may be assigned to or be selected by the player. Preferably, each bonus hand comprises a Royal 9 hand comprising a face card and a 9 card. In an embodiment where a single bonus hand is assigned to or selected by the player, the hand preferably comprises a King and a 9 card of one or more suits.

Further objects, features, and advantages of the present invention over the prior art will become apparent from the detailed description of the drawings which follows, when considered with the attached figures.

### DESCRIPTION OF THE DRAWINGS

FIG. 1 is a plan view of a Baccarat casino card game layout in combination with an optional progressive award bonus bet on a ROYAL 9® card combination of the present invention on a casino card playing table layout for carrying out the steps of the method of the present invention, showing the player layouts, each including three assigned unique ROYAL 9® card combination and payout tables, facing the players and the dealer layout and payout tables facing the dealer on the other side of the playing table from the players;

FIG. 2 is an exploded plan view of a player layout from FIG. 1, showing betting locations, three uniquely assigned ROYAL 9® card combinations and the progressive payouts;

FIG. 3 is an elevational view of an electronic ROYAL 9® progressive meter display at a location visible to each player at the playing table, showing one Major ROYAL 9® progressive jackpot meter indicating the cumulative payout amount and a ROYAL 9® payout table showing personal and community progressive payouts;

FIG. 4 is an elevational view of an electronic ROYAL 9® progressive meter display at a location visible to each player at the playing table, showing one Major ROYAL 9® progressive jackpot meter, a King 9 Banker Hand Progressive meter, and a King 9 Player Progressive meter indicating the cumulative payout amounts and a ROYAL 9® payout table showing personal and community progressive payouts;

FIG. 5 is an elevational view of the Baccarat casino card game layout in combination with an optional progressive award bonus bet on a ROYAL 9® card combination layout of the present invention shown on a screen of an electronic simulation device showing a simulation of the player layouts and payout tables and the dealer layout and payout tables and including the three uniquely assigned player ROYAL 9® card combinations;

FIG. 6 is an elevational view of the Baccarat casino card game layout in combination with an optional progressive award bonus bet on a ROYAL 9® card combination layout of the present invention shown on a screen of a computer device showing a simulation of the Banker Hand, the Player Hand, the player layouts and payout tables and the dealer layout and payout tables, and the three uniquely assigned player ROYAL 9® card combinations;

FIG. 7 is an elevational view of the Baccarat casino card game layout in combination with an optional progressive award bonus bet on a ROYAL 9® card combination layout of the present invention shown on a touch screen of a wireless cell phone or tablet type device showing a simulation of the Banker Hand, the Player Hand, the player layout and payout table including the three uniquely assigned ROYAL 9® card combinations;

FIG. 8 illustrates one embodiment of an electronic presentation device in the form of a gaming machine of the invention;

FIG. 9 illustrates additional aspects of the gaming machine illustrated in FIG. 8; and

FIG. 10 is a flow chart of a method or process in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods of playing and presenting games, as well as gaming devices (such as gaming tables and gaming machines) and gaming systems for presenting games. One embodiment of the invention is a Baccarat or Baccarat-type game which includes a bonus bet. Preferably, the bonus bet offers a player an opportunity for a bonus award or jackpot which is individualized (e.g. where a winning bonus bet to the player is not shared with the other players).

As used herein, the following terms may have the following meaning:

“Progressive Sensor” designates the betting spot for the ROYAL 9® progressive wagers, having an electronic sensor to detect the optional ROYAL 9® Progressive Bonus Wager placed there.

“Starting Meter” designates the starting amount of a progressive jackpot.

“Increment Rate” designates the percent of each dollar wagered that goes to the progressive jackpot meter.

“Royal 9 combination” or ROYAL 9® designates a nine card and a face card (Jack, Queen, or King) of one or more suits, preferably dealt as the initial two cards dealt to a Player hand and/or a Banker hand.

“Secondary Seed” designates the percent of each dollar that is accrued in a fund that will be added to the Starting Meter after a progressive jackpot is won.

One embodiment of the invention is an individualized bonus or progressive system and method for casino Baccarat. In one embodiment, the bonus or progressive system includes at least one bonus or progressive award associated with a game of casino Baccarat where players do not split progressives or bonuses. In one embodiment, each player or player position is assigned at least one unique Royal 9 combination that will trigger a progressive jackpot award, allowing only one player to win the prize (such as a full jackpot value or other bonus value, without splitting such value with one or more other players).

A related advantage of the present invention is that by providing only one winning combination, the frequency of winning the bonus wager will be greater (since each player has at least one unique Royal 9 combination) so that there is a greater chance of the jackpot being initiated along with a greater reward for the one player that wins the jackpot.

In brief, in one embodiment the present invention provides a method for administering a casino Baccarat card game having an individualized player progressive wager and payout by assigning each player position with at least one unique ROYAL 9® combination of cards to match to the community Player hand and/or community Banker hand to trigger a jackpot or progressive payout when an optional bonus bet is placed by the player to allow the jackpot or bonus to be won by only one of the players at the table.

In one embodiment, the optional ROYAL 9® progressive wager (which may also be referred to as a jackpot wager or a bonus wager) of the present invention is paid out to specific face card and nine card combinations according to a two-tiered ROYAL 9® progressive payout table.

A Personal ROYAL 9® progressive payout table preferably awards at least one type of single cumulated progressive jackpot to only one player having a uniquely assigned ROYAL 9® card combination appearing in one or both of the initial dealt two card Banker hand or Dealer hand. In one embodiment,each player layout preferably has a single unique ROYAL 9® card combination assigned thereto (or each player is otherwise assigned such card combinations). In another embodiment, each player layout preferably has three assigned unique ROYAL 9® card combinations: a King card and a 9 card each of a specific suit, a Queen card and a 9 card each of a specific suit, and a Jack card and a 9 card each of a specific suit, wherein none of the other player positions have the same ROYAL 9® card combinations.

There are preferably three different Personal ROYAL 9® progressive jackpots designated in the Personal ROYAL 9® progressive jackpot payout table utilizing only the unique assigned ROYAL 9® card combinations on each player layout:

A Major ROYAL 9® Progressive Jackpot designates the progressive jackpot (such as designated by a meter) that represents both the Player hand and the Banker hand containing the same one of the player layout unique assigned progressive ROYAL 9® combinations.

A King/9 Banker Progressive Jackpot designates the progressive jackpot (such as designated by a meter) that represents the Banker hand containing a player layout unique assigned King/9 progressive combination.

A King/9 Player Jackpot designates the progressive jackpot meter that represents the Player hand containing a player layout unique assigned King/9 progressive combination.

Personal ROYAL 9® Progressive Combinations Payouts—each betting position has three unique combinations that can trigger a progressive payout:

1) Exact Match Personal ROYAL 9® Progressive Combination pays 100% of the Major Jackpot—The player hand and banker hand both have the exact same unique personal progressive combination assigned to a player layout.

2) Any Two Personal ROYAL 9® Progressives Combinations pay 10% of the Major Jackpot—the Player hand and Banker hand each contain a personal progressive combination assigned to a betting position.

3) Personal King/9 on Banker Hand pays 100% of the King/9 Banker Progressive Jackpot—The Banker hand contains a King/9 combination uniquely assigned to a player layout.

4) Personal King/9 on Player Hand pays 100% of the King/9 Player Progressive Jackpot—The Player hand contains a King/9 combination assigned to a betting position.

A general ROYAL 9® Progressive Payout Table relates to ROYAL 9® card combinations in the Banker hand and Player hand which are paid out to any player making the optional ROYAL 9® Progressive Bonus bet and not having the unique assigned ROYAL 9® card combination in the player's layout. If a player is entitled to a Personal ROYAL 9® Progressive Jackpot payout because the Banker hand or Player hand contain any of the player's unique assigned ROYAL 9® card combinations, the player is paid the Personal ROYAL 9® Progressive Jackpot payout and not the smaller payout. The general ROYAL 9® Progressive Payout Table designates payouts on ROYAL 9® card combinations may be as follows:

a) Any ROYAL 9®—either the Player hand or the Banker hand contains a ROYAL 9® card combination

b) Any Suited ROYAL 9®—either the Player hand or the Banker hand contains a ROYAL 9® where both cards are of the same suit

c) Royal 9 Tie Hand—both the Player hand and the Banker hand each have a ROYAL 9®; not necessarily the same ROYAL 9® combination,

d) Suited ROYAL 9® Tie Hand—both Player hand and the Banker hand each have a suited ROYAL 9®; not necessarily the same suited ROYAL 9®.

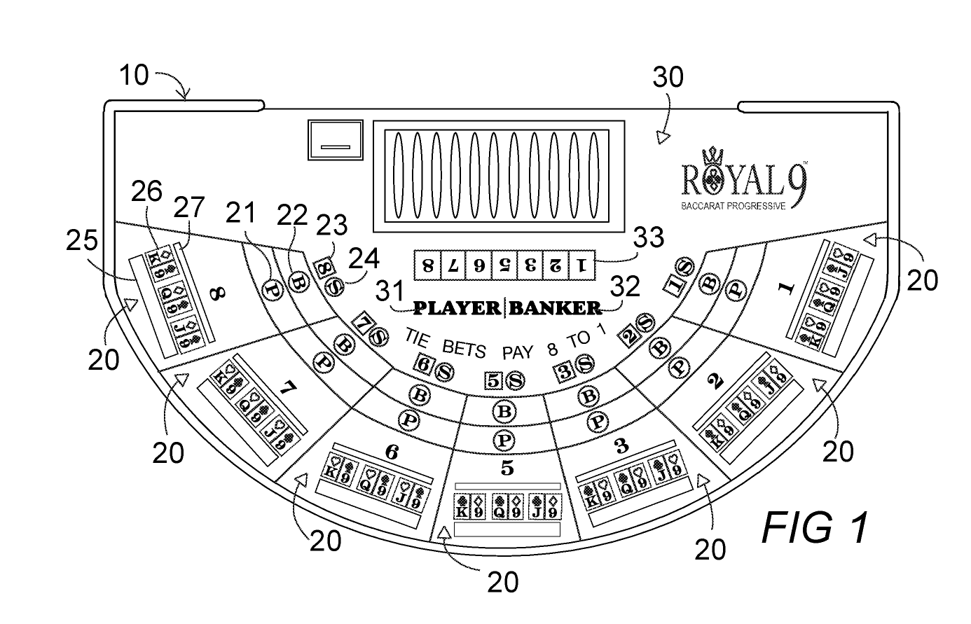

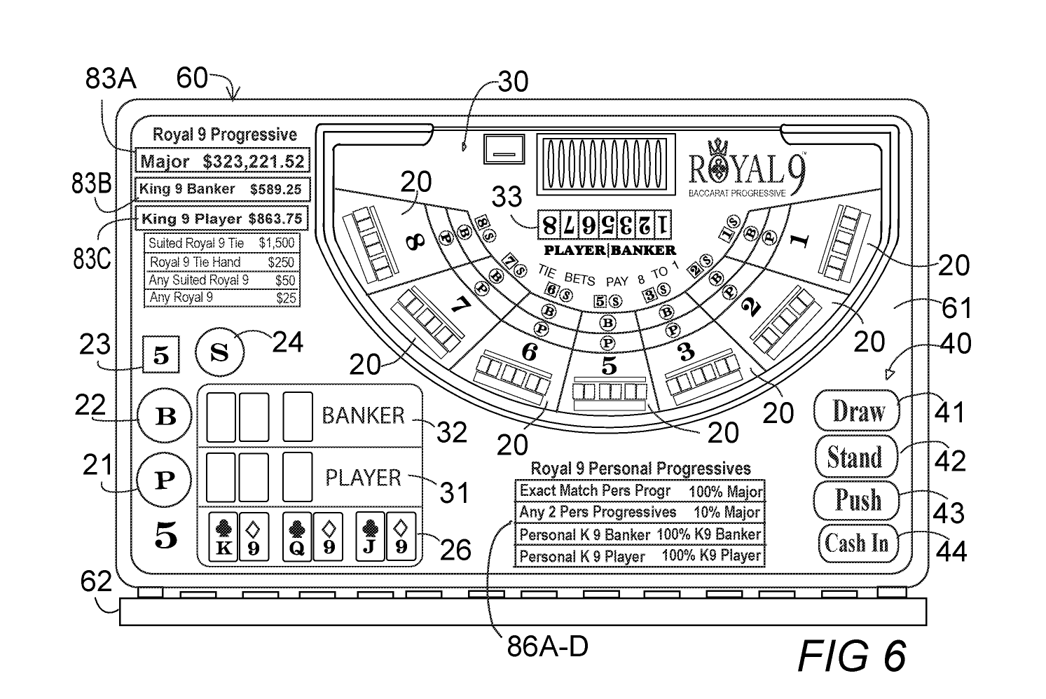

In FIGS. 1-7, the present invention comprises a method of administering a Baccarat casino card game in combination with an optional jackpot or bonus bet on personalized outcome, such as a ROYAL 9® card combination. In one embodiment, the method comprises:

Providing at least one playing table 10, each of the at least one playing tables comprising a surface illustrated to define a dealer layout area 30 and a plurality of player layout areas 20, each player layout area of the plurality of player layout areas illustrated to define a plurality of distinct locations comprising a Baccarat Player Hand win betting location 21, a Baccarat Banker Hand win betting location 22, a Baccarat Banker Hand and Baccarat Player Hand tie betting location 23, a ROYAL 9® progressive optional bonus betting location 24 for dealt Banker hand and Player hand ROYAL 9® card combinations of a face card and a nine card progressive award bonus wins, a unique ROYAL 9® card combinations location 26 indicating at least one unique player individually assigned ROYAL 9® card combination of a face card and a nine card of specified suits, and a ROYAL 9® card combination progressive payout table 25;

Providing at or proximate to the at least one playing table at least one standard 52-card deck of physical playing cards randomized to form at least one 52-card deck of Baccarat physical playing cards;

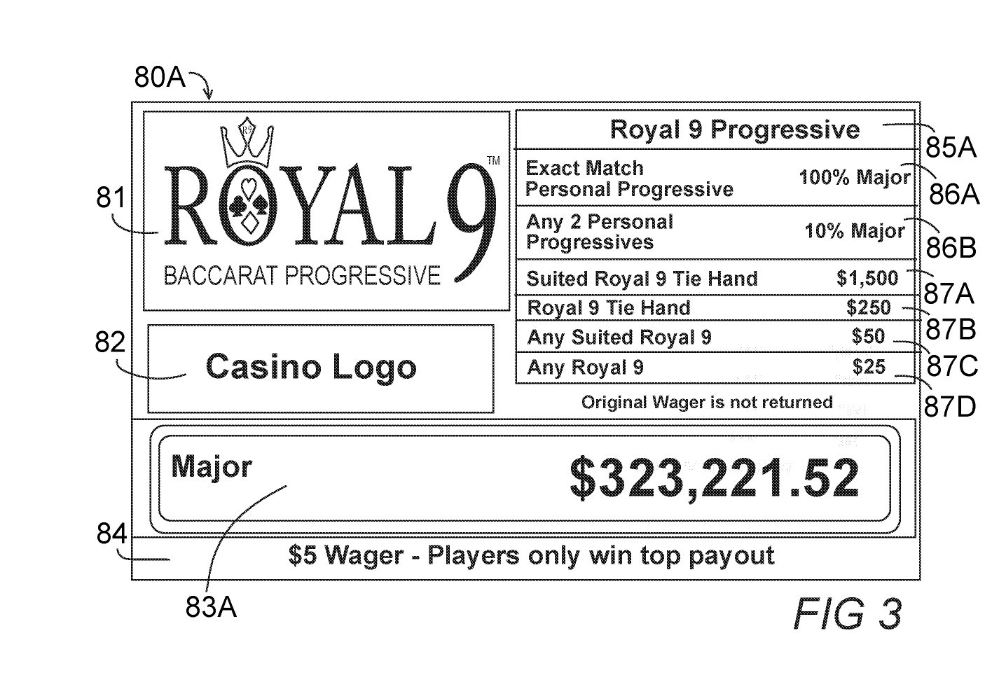

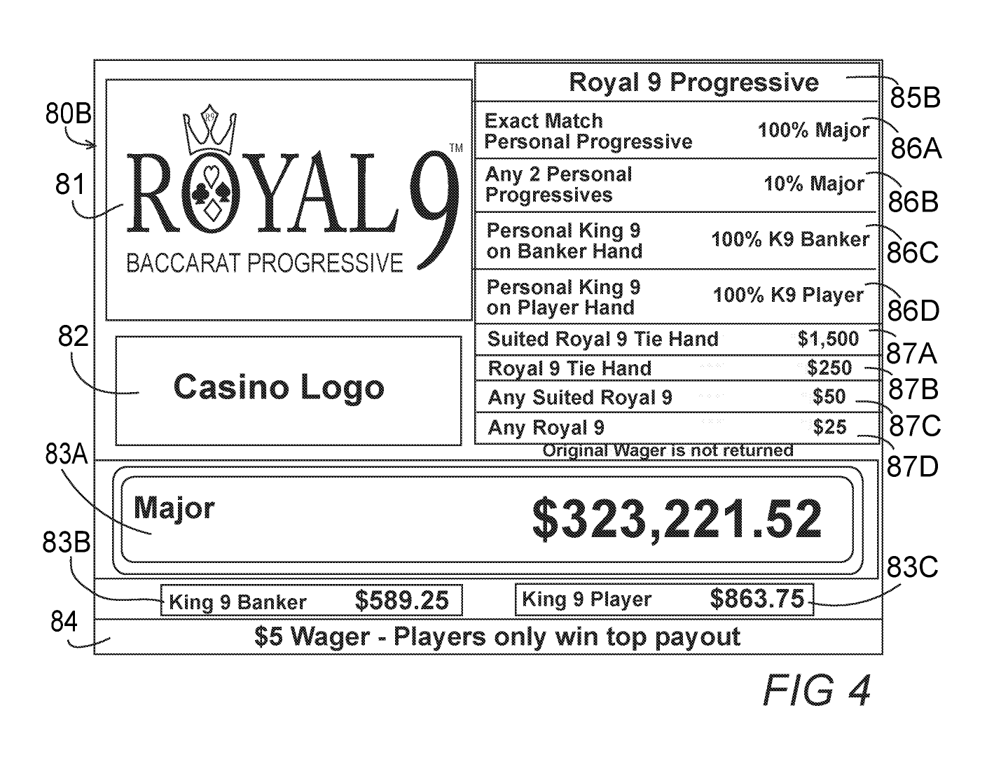

Providing an electronic means under each player optional bet location 24 for sensing and reporting ROYAL 9® progressive bonus bets at the at least one playing table 10 (preferably a radio wave detector sensing the placement of a progressive betting chip containing a transmitter on the sensor optional progressive betting location 24), and programmable means for calculating a percentage of the ROYAL 9® progressive bonus bets to create at least one ROYAL 9® Progressive cumulative jackpot and providing at least one electronic ROYAL 9® progressive meter display 80A and 80B, as shown in FIGS. 3 and 4, at a location visible to each player at each playing table, and an electronic means for updating the ROYAL 9® progressive meter display with at least one ROYAL 9® progressive jackpot cumulative payout amount 83A based on a percentage of all ROYAL 9® progressive bonus bets made;

Receiving one bet taken from one of the three Baccarat alternate betting locations including a Baccarat Player Hand win bet, a Baccarat Banker Hand win bet, or a Baccarat Banker Hand and Baccarat Player Hand tie bet in the form of at least one physical monetary token placed in the associated Baccarat Player Hand betting location, the Baccarat Banker Hand win betting location, or the Baccarat Banker Hand and Baccarat Player Hand tie betting location of each player layout area of the plurality of player layout areas where a bet has been made;

Receiving an optional ROYAL 9® progressive bonus bet, such as a $5 chip, in the form of at least one physical monetary token placed in the ROYAL 9® progressive optional bonus betting location 24 of each player layout area 20 of the plurality of player layout areas where a bet has been made;

Recording and locking in all ROYAL 9® bonus wagers in dealer progressive betting demarcation boxes 33 corresponding to each player locations (1-3 and 5-8) of players making the progressive bet;

Collecting all ROYAL 9® bonus wagers;

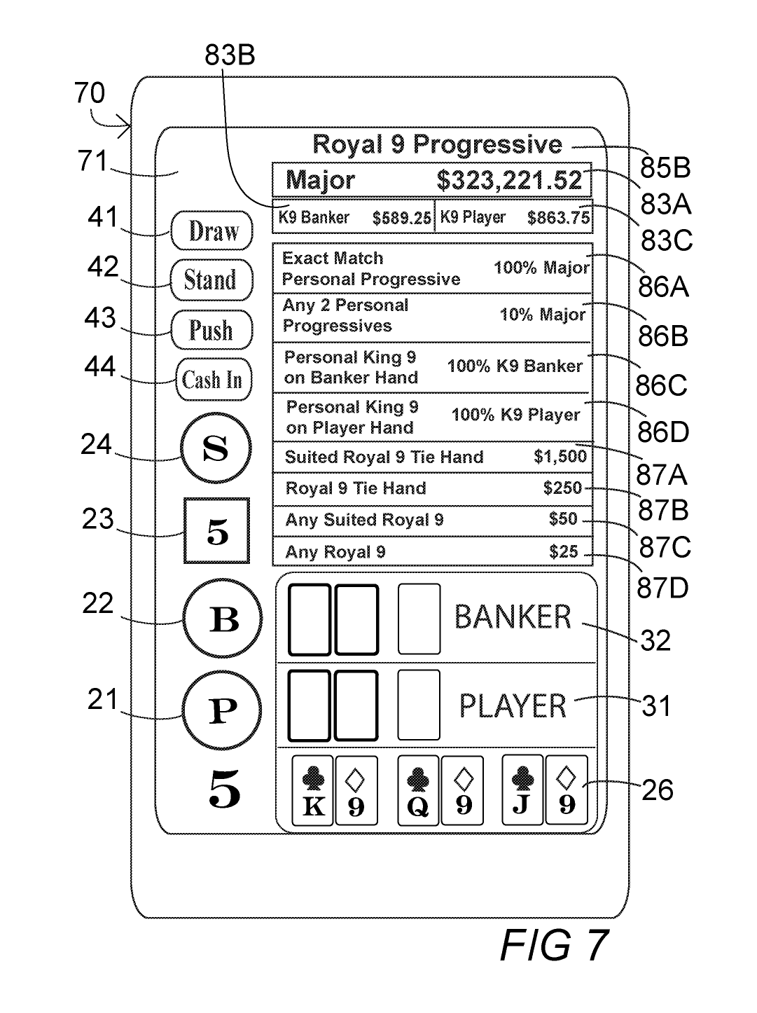

Distributing, on the surface of the playing table and from the at least one randomized 52-card deck of physical Baccarat playing cards, a two-card face-up Baccarat Banker Hand 32 and a two-card face-up Baccarat Player Hand 31 as shown in FIGS. 1 and 7;

Analyzing the initial dealt two-card face-up Baccarat Banker Hand 32 and the initial dealt two-card face-up Baccarat Player Hand 31 to determine if the Baccarat Player Hand, the Baccarat Banker Hand, or both contain a ROYAL 9® card combination:

Paying out any winning ROYAL 9® progressive bonus bets according to the ROYAL 9® progressive payout table 85A and 85B, as shown in FIGS. 3 and 4; and

Playing out the Baccarat hand in accordance with approved Baccarat procedures.

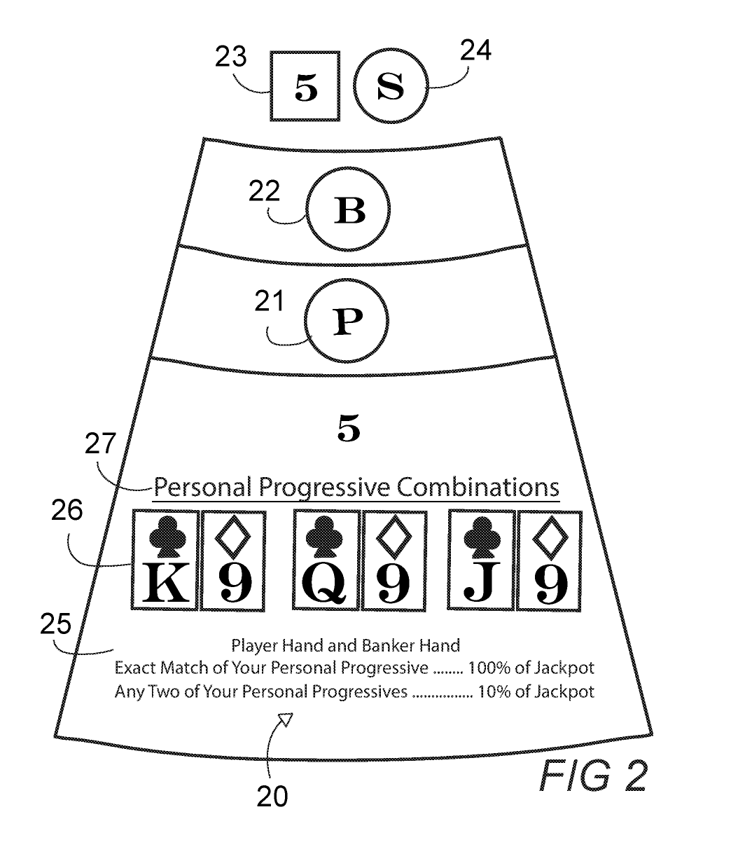

The player layout location 20, as shown in FIG. 2 indicating at least one unique player individually assigned ROYAL 9® card combination comprises a location indicating three unique ROYAL 9® combinations 26 assigned to the single player location comprising a unique King and Nine card combination, a unique Queen and Nine card combination, and a unique Jack and Nine card combination; and paying out any winning ROYAL 9® Progressive bonus bets according to the ROYAL 9® card combination Personal Progressive payout table 80A, as shown in FIG. 3, comprises paying out to a ROYAL 9® progressive optional bonus betting player as follows:

100% of a Major Progressive meter 83A for an Exact Match Personal Progressive, having both the Banker Hand 32 and the Player Hand 31exactly matching one of the optional bonus betting player's uniquely assigned ROYAL 9® card combinations 26 (as indicated in line 86A of the ROYAL 9® Progressive payout table 85A of FIG. 3 and table 85B of FIG. 4);

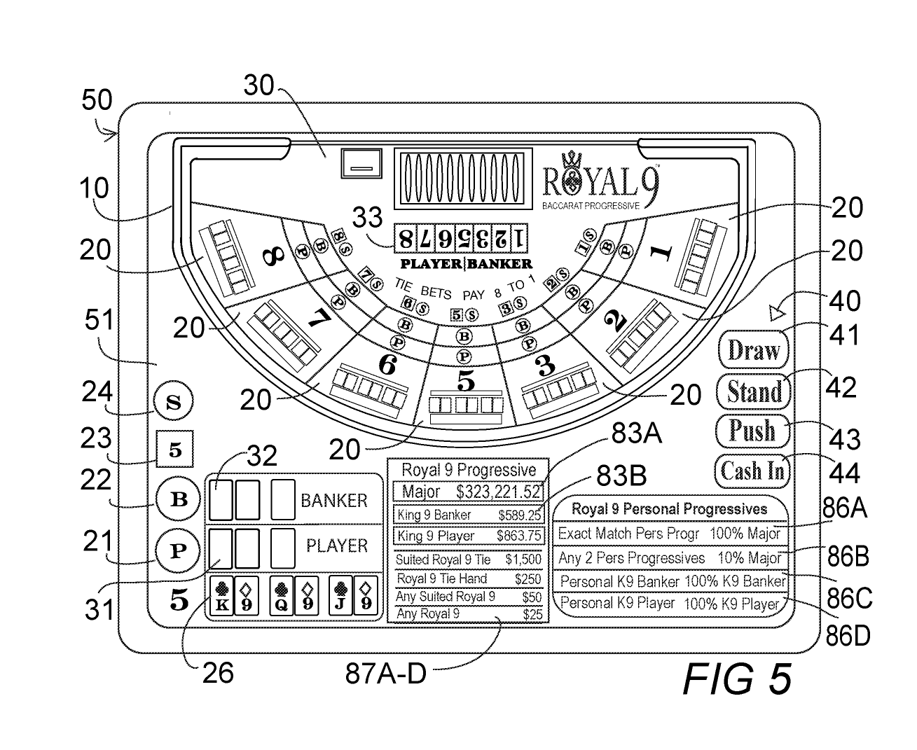

10% of the Major Progressive meter 83A for Any Two Personal Progressives, having the Banker Hand 32 matching one of the optional betting player's uniquely assigned ROYAL 9® card combinations and the Player Hand 31 matching another of the optional bonus betting player's uniquely assigned ROYAL 9® card combinations 26, as shown in FIGS. 5, 6, and 7 (as indicated in line 86B of the ROYAL 9® Progressive payout table 85A of FIG. 3 and table 85B of FIG. 4).

In FIG. 4, the method further comprises paying out any winning ROYAL 9® Progressive bonus bets according to the ROYAL 9® card combination Personal Progressive payout table 85B, shown in FIG. 4, comprising paying out to a ROYAL 9® Progressive optional bonus betting player:

100% of a King 9 Banker Progressive meter 83B for the Banker Hand 32 having a King 9 card combination matching the optional betting player's uniquely assigned King 9 card combination 26 (as indicated in line 86C of the ROYAL 9® Progressive payout table 85B of FIG. 4);

100% of a King 9 Player Progressive meter 83C for the Player Hand having a King 9 card combination matching the optional betting player's uniquely assigned King 9 card combination 26 (as indicated in line 86D of the ROYAL 9® Progressive payout table 85B of FIG. 4).

In lines 87A-87D of both ROYAL 9® Progressive payout tables 85A of FIGS. 3 and 85B of FIG. 4, the method shows paying out any winning ROYAL 9® Progressive bonus bets according to the ROYAL 9® card combination general Progressive payout table comprises paying out to a ROYAL 9® progressive optional bonus betting player:

$1,500 for any Suited ROYAL 9® Tie Hand (line 87A)

$250 for any ROYAL 9® Tie Hand (line 87B)

$50 for any Suited ROYAL 9® (line 87C)

$25 for any ROYAL 9® (line 87D).

In the event that a hand qualifies in multiple payouts, only the highest payout will be awarded to each player with an active ROYAL 9® progressive wager.

At least one standard 52-card deck of physical playing cards may comprise providing any of number of standard 52-card decks of playing cards taken such as one deck, two decks, four decks, six decks, and eight decks, preferably randomized to form a single-deck or multi-deck stack of Baccarat physical playing cards. The odds and payouts may change depending on the number of decks used. In one embodiment, cards might be shuffled by one or more card shuffling devices and cards might be dealt from those shuffled decks. The cards might also be associated with a card shoe and be dealt from the shoe.

Providing at least one playing table may comprise providing a plurality of playing tables all contributing to the ROYAL 9® progressive jackpot making the jackpot higher faster as the number of tables increases.

In one embodiment, aside from the features described above including a unique table layout, the playing table may include additional or other features. For example, the playing table may include one or more devices for accepting or interfacing with one or more physical elements having associated monetary value. Such devices might comprise, for example, a coin or currency acceptor, a card reader (for credit cards, account cards, bank cards and the like), a ticket reader, wireless device readers or communication interfaces or the like, whereby funds may be associated with the table and game via a player (for example, in exchange for providing such funds, the player may be provided with chips for use in placing wagers). The playing table might also include playing card-related devices, such as a card shoe, a card shuffler and/or a playing card reader (such as for validating dealt cards or even scanning and then causing images of the cards to be displayed on one or more video displays). The playing table might also include one or more cash-out mechanisms or the like, such as for paying a player winnings (for example, a player might redeem chips for a value ticket, money, or transfer funds to a casino account or the like). The playing table may include additional dealer and/or player controls, may include at least one controller, and may communicate with one or more external systems or devices, such as a casino player tracking system, casino accounting system or the like. As one example, the playing table might include at least one dealer touchscreen input device which is configured to accept touch input of a dealer. Such a touchscreen might comprise a 7″ touchscreen from Touchstone Technology, Inc. (www.touchstn.com; Rochester, N.Y., USA). This touchscreen might interface with a table controller (such as having a processor, a memory and one or more communication interfaces), to which is also coupled the card reader, bet sensors, progressive display(s) and/or other features, whereby the controller may generate information which is displayed on the displays (such as progressive jackpot values, etc.) and whereby the dealer may provide certain inputs (such as to open and close betting and the like, whereby only bets detected by the sensors between during a betting period may be registered).

Providing a playing table may comprise providing a simulation device, which may be a mechanical simulation device, comprising the surface displaying an illustration to define the plurality of player layout areas. The various layout areas, including the features thereof, might be comprise defined printed areas or features on the table, or various features might be defined by raised or depressed areas in the table surface.

In FIGS. 5, 6, and 7, the method of the present invention may be carried out by providing an electronic simulation device comprising a screen, such as a video display, configured to display a virtual representation of a playing surface illustrated to define a dealer layout area and a plurality of player layout areas, each player layout area of the plurality of player layout areas illustrated to define a plurality of distinct locations comprising a Baccarat Player Hand win betting location 21, a Baccarat Banker Hand win betting location 22, a Baccarat Banker Hand and Baccarat Player Hand tie betting location 23, a ROYAL 9® progressive optional bonus betting location 24 for dealt Banker Hand and Player Hand ROYAL 9® card combinations of a face card and a nine card progressive award bonus wins, a location indicating at least one unique player individually assigned ROYAL 9® card combination of a face card and a nine card of specified suits 26, and a ROYAL 9® card combination progressive payout table 85B, as shown in FIG. 7. Such a device might comprise, for example a gaming machine having a housing or cabinet, a controller and one or more video displays.

In FIGS. 5, 6, and 7, the method of the present invention using an electronic simulaton device 50, 60, and 70 involves providing at least one standard 52-card deck of virtual playing cards randomized to form at least one 52-card deck of virtual Baccarat playing cards. Providing at least one standard 52-card deck of virtual playing cards may comprise providing providing any of the numbers of standard 52-card decks of virtual playing cards taken from the list of numbers of standard 52-card decks of virtual playing cards including one deck, two decks, four decks, six decks, and eight decks randomized to form a virtual deck of Baccarat playing cards.

Further steps in the method of the present invention using an electronic simulation device comprise:

Providing an electronic means for recording individual player ROYAL 9® progressive bets on optional ROYAL 9® progressive award betting location 24 on the at least one virtual representation of a playing surface 51, 61, and 71 and providing at least one virtual representation of a ROYAL 9® progressive meter display, and an electronic means for updating the ROYAL 9® progressive meter display with at least one ROYAL 9® progressive jackpot cumulative payout amount based on a percentage of all ROYAL 9® progressive bonus bets made;

Receiving one bet taken from one of the three Baccarat alternate betting locations including a Baccarat Player Hand win bet, a Baccarat Banker Hand win bet, or a Baccarat Banker Hand and Baccarat Player Hand tie bet, the bet in the form of at least one virtual monetary token virtually indicated in the associated Baccarat Player Hand betting location 21, the Baccarrat Banker Hand win betting location 22, or the Baccarat Banker Hand and Baccarat Player Hand tie betting location 23 of each player layout area of the plurality of player layout areas where a bet has been made.

Standard input means are used, such as a mouse, keypad, joystick, touchscreen or other electronic input means for selecting a location on the screen 50, 60, or 70 to carry out the steps of the method of the present invention using an electronic simulation device, including the following steps of:

Receiving an optional ROYAL 9® progressive bonus bet in the form of at least one virtual monetary token virtually indicated in the ROYAL 9® progressive optional bonus betting location 24 of each player layout area 20 of the plurality of player layout areas where a bet has been made;

Recording and locking in all ROYAL 9® bonus wagers (such as by registering those wagers via the device);

Collecting all ROYAL 9® bonus wagers (such as by registering those wagers via the device);

Virtually distributing, on the virtual representation of a playing surface, from the at least one randomized 52-card deck of virtual Baccarat playing cards, a two-card face-up Baccarat Banker Hand 32 and a two-card face-up Baccarat Player Hand 31;

Analyzing the initial dealt two-card face-up Baccarat Banker Hand and the initial dealt two-card face-up Baccarat Player Hand to determine if the Baccarat Player Hand, the Baccarat Banker Hand, or both contain a ROYAL 9® card combination:

Paying out any winning ROYAL 9® progressive bonus bets according to the Royal 9 card combination personal and community progressive payout tables as indicated above, but employing virtual payouts carried out electreonically.

Playing out the Baccarat hand in accordance with approved Baccarat procedures.

In FIG. 7, providing an electronic simulation device may comprise providing a handheld electronic simulation device 70, the screen 71 of the electronic simulation device configured as a touch screen of the handheld electronic simulation device.

Providing an electronic simulation device may comprise providing an electronic simulation device having a wired or wireless connection to a remote networkand may comprise providing a communication electronic simulation device, a computer, a handheld device, a telephonic device, an entertainment device, a gaming device, a television device, or other electronc simulation device.

Providing at least one electronic simulation device may comprise providing a plurality of electronic simulation devices all contributing to the ROYAL 9® progressive jackpot.

In use, as shown in FIG. 1, an example of the unique assigned ROYAL 9® card combinations for the optional personal ROYAL 9® progressive payouts are indicated for the individual player layouts as follows:

| | |
|---|---|
| Player layout 1 | King of Spades and 9 of Hearts |
| | Queen of Spades and 9 of Hearts |
| | Jack of Spades and 9 of Hearts |
| Player layout 2 | King of Spades and 9 of Diamonds |
| | Queen of Spades and 9 of Diamonds |
| | Jack of Spades and 9 of Diamonds |
| Player layout 3 | King of Clubs and 9 of Hearts |
| | Queen of Clubs and 9 of Hearts |
| | Jack of Clubs and 9 of Hearts |
| Player layout 5 | King of Clubs and 9 of Diamonds |
| | Queen of Clubs and 9 of Diamonds |
| | Jack of Clubs and 9 of Diamonds |
| Player layout 6 | King of Hearts and 9 of Spades |
| | Queen of Hearts and 9 of Spades |
| | Jack of Hearts and 9 of Spades |
| Player layout 7 | King of Hearts and 9 of Clubs |
| | Queen of Hearts and 9 of Clubs |
| | Jack of Hearts and 9 of Clubs |
| Player layout 8 | King of Diamonds and 9 of Spades |
| | Queen of Diamonds and 9 of Spades |
| | Jack of Diamonds and 9 of Spades |

Using multiple decks of cards enables winning combinations. Winning Personal ROYAL 9® Progressive Combinations for the above uniquely assigned player layout ROYAL 9® card combinations would be as follows:

Any Two Personal Progressives 10% of the Major Jackpot—Using the personal progressive combinations in player layout 1, below are the 6 winning combinations for the 10% Jackpot:

| Combination | Banker Hand | Player Hand |
|---|---|---|
| 1 | King Spades/9 Hearts | Queen Spades/9 Hearts |
| 2 | King Spades/9 Hearts | Jack Spades/9 Hearts |
| 3 | Queen Spades/9 Hearts | King Spades/9 Hearts |
| 4 | Queen Spades/9 Hearts | Jack Spades/9 Hearts |
| 5 | Jack Spades/9 Hearts | King Spades/9 Hearts |
| 6 | Jack Spades/9 Hearts | Queen Spades/9 Hearts |

Exact Match Personal Progressive 100% of the Major Jackpot—Using the personal progressive combinations in player layout 1, below are the 3 winning combinations for the 100% Jackpot:

| Combination | Banker Hand | Player Hand |
|---|---|---|
| 1 | King Spades/9 Hearts | King Spades/9 Hearts |
| 2 | Queen Spades/9 Hearts | Queen Spades/9 Hearts |
| 3 | Jack Spades/9 Hearts | Jack Spades/9 Hearts |

Personal King/9 on Banker hand for 100% of the King 9 Progressive jackpot—Using the personal progressive combinations in player layout 1, below is the 1 winning combinations for the 100% Jackpot:

| Combination | Banker Hand |
|---|---|
| 1 | King Spades/9 Hearts |

Personal King/9 on Player hand for 100% of the King 9 Progressive jackpot—Using the personal progressive combinations in player layout 1, below is the 1 winning combinations for the 100% Jackpot:

| Combination | Player Hand |
|---|---|
| 1 | King Spades/9 Hearts |

In the event that a hand qualifies in multiple payouts, only the highest payout will be awarded to each player with an active ROYAL 9® progressive wager.

As with the gaming table, the electronic simulation device, such as the gaming machine, may include one or more devices for associating funds therewith. In this case, instead of being issued chips for wagering, the associated funds may be used to establish a credit balance which may be used by the player to place wagers.

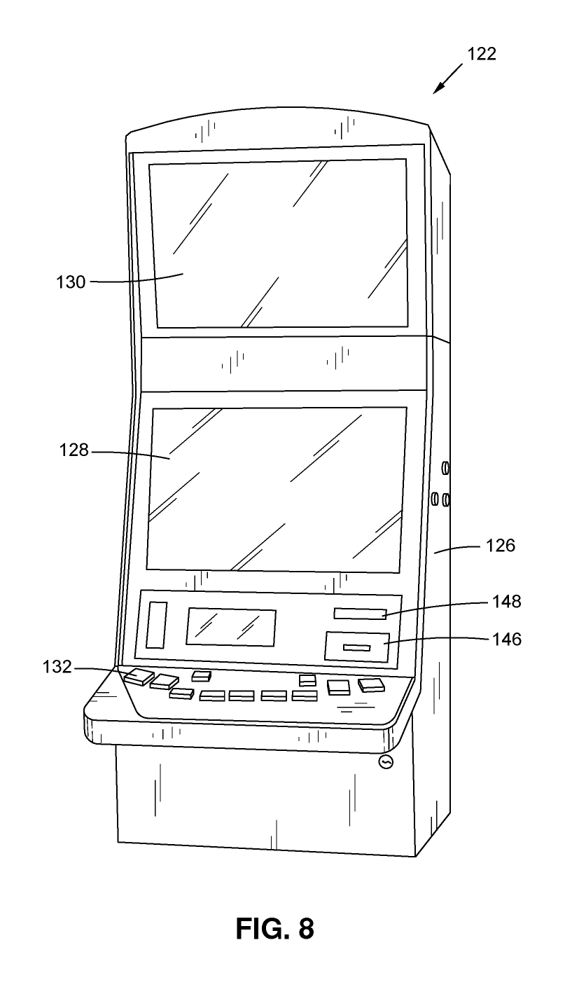

In one embodiment, the electronic simulation device may comprise a gaming machine. One configuration of a gaming machine 122 is illustrated in FIG. 8. As illustrated, the gaming machine 122 generally comprises a housing or cabinet 126 for supporting and/or enclosing various components required for operation of the gaming machine. In the embodiment illustrated, the housing 126 includes a door located at a front thereof, the door capable of being moved between an open position which allows access to the interior, and a closed position in which access to the interior is generally prevented. The configuration of the gaming machine 122 may vary. In the embodiment illustrated, the gaming machine 122 has an “upright” configuration. However, the gaming machine 122 could have other configurations, shapes or dimensions (such as being of a “slant”-type, “bar-top” or other configuration).

The gaming machine 122 preferably includes at least one first display device 128 configured to display game information. The display device 128 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). As one example, the display might comprise a 19″ monitor from iBase (www.ibase.com.tw; Taipei, Taiwan, R.O.C.). The display device 128 may be capable of projecting or displaying a wide variety of information, including images, symbols and other indicia or information associated with game play, game promotion or other events. The gaming machine 122 might include more than one display device, such as a main or first display device 128 and a secondary display device 130. The two or more display devices might be associated with the housing or, as illustrated in FIG. 8, the gaming machine 122 might also include a top box or other portion which includes the one or more second display devices 130. Also, the gaming machine 122 might include side displays (such as mounted to the exterior of the housing 126) and might include multiple displays of differing sizes.

As described in more detail below, the gaming machine 122 is preferably configured to present one or more games upon a player making a monetary payment or wager. In this regard, as described in more detail below, the gaming machine 122 includes mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 122 preferably includes a mechanism or means for returning unused monetary funds and/or dispensing winnings to a player.

The gaming machine 122 preferably includes one or more player input devices 132 (such as input buttons, plunger mechanisms, a touch-screen display, joystick, touch-pad or the like). These one or more devices 130 may be utilized by the player to facilitate game play, such as by providing input or instruction to the gaming machine 122. For example, such input devices 130 may be utilized by a player to place a wager, cause the gaming machine 122 to initiate a game, to “cash out” of the gaming machine, or to provide various other inputs.

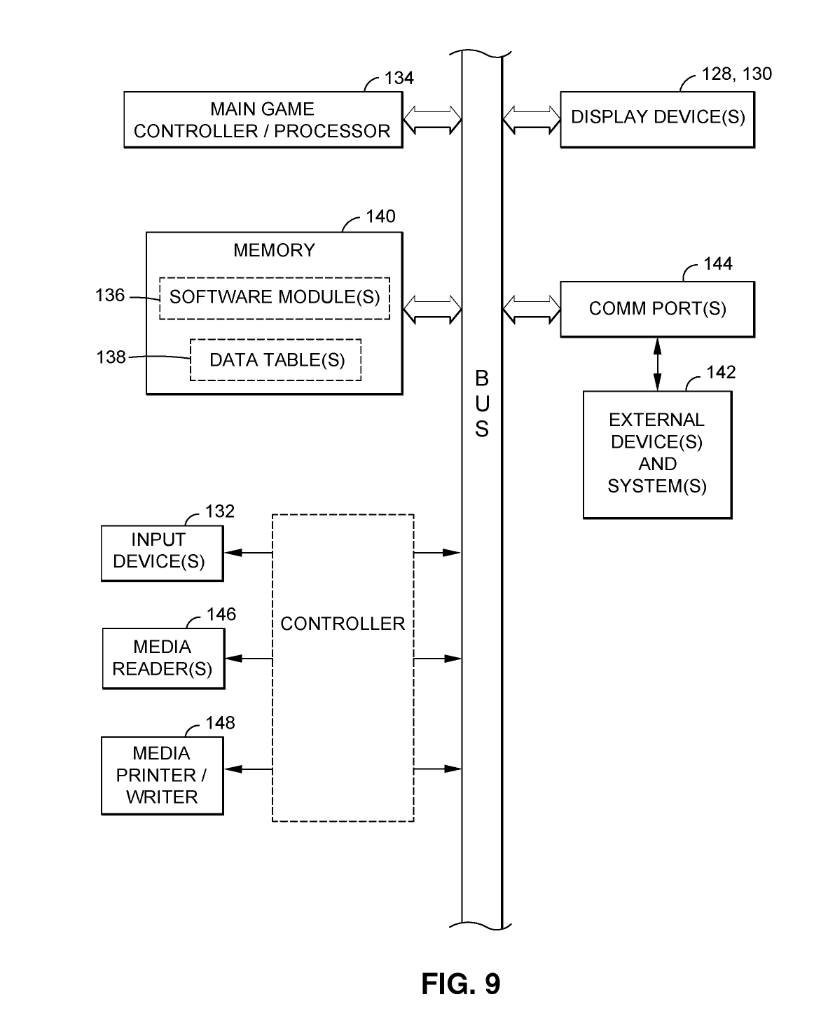

Referring to FIG. 9, in one preferred embodiment, the gaming machine 122 includes at least one microprocessor or controller 134 for controlling the gaming machine, including receiving player input and sending output signals for controlling the various components or peripheral devices of the machine 122 (such as generating game information for display by the display devices 128,130). One example of a controller 134 is a Kontron KTQ87/mITX embedded Mini-ITX Motherboard with Intel Z87 Chipset and 4^{th} Generation Intel 17/5/13 Dual and Quad Core CPUs (www.kontron.com; Augsburg, Germany). The controller 134 may be arranged to receive information regarding funds provided by a player to the gaming machine 122, receive input such as a purchase/bet signal when a purchase/bet button is depressed, and receive other inputs from a player. The controller may be arranged to generate information regarding a game, such as generating game information for display by the at least one display device 128,130 (such as information comprising images of playing cards, as detailed below), for determining winning or losing game outcomes and for displaying information regarding awards for winning game outcomes, among other things.

The controller 134 may be configured to execute machine readable code or “software” or otherwise process information, such as obtained from a remote server. Software 136 or other instructions may be stored at a memory or data storage device 140, e.g. in a fixed or non-transitory configuration. The memory may also store other information or data 140, such as data stored in table or other forms (including, but not limited to look-up tables, pay tables and other information including tracked game play information). The gaming machine 122 may also include one or more random number generators for generating random numbers (such as implemented by a random number generator software module stored in the memory 140 and executable by the processor 134), such as for use in selecting virtual playing cards from one or more decks of playing cards to be graphically dealt and for presenting the game in a random fashion (e.g. whereby the game is presented in a manner in which the player cannot control the outcome) or pseudo-random fashion (e.g. such as where the game includes a skill component which can affect the outcome of the game). One embodiment of a random RNG engine, RNGCryptoServiceProvider Class, by Microsoft, is set forth below in Table 1.

TABLE 1

Language: c# .net
Code snippet:

//
// Summary:
// Fills an array of bytes with a cryptographically strong

sequence of random values.

```
//
// Parameters:
  // data:
  // The array to fill with a cryptographically strong
```

sequence of random values.

```
  //
  // Exceptions:
  // T:System.Security.Cryptography.
    CryptographicException:
  // The cryptographic service provider (CSP) cannot be
      acquired.
  //
  // T:System.ArgumentNullException:
  // data is null.
```

static RNGCryptoServiceProvider _crypto = new
RNGCryptoServiceProvider( );
var bytes = new byte[1];
_crypto.GetBytes(bytes);

Preferably, the controller 134 is configured to execute machine readable code or instructions (e.g. software) which are configured to implement the game. In this regard, the gaming machine 122 is specially configured to present the game of the invention via specific software and/or hardware which causes the gaming machine to operate uniquely. For example, the controller 134 of the gaming machine 122 may be configured to detect a wager, such as a signal from a player's depressing of the “bet one” button (or other bet input, such as to place a bet or wager upon a Player hand, Banker hand, a “tie” and/or to place a bonus bet or wager, as detailed herein). Upon such an event and/or the player otherwise signaling the gaming machine to present the game, the controller may be configured to cause the at least one display 128 to display unique information, such as a unique graphical interface or unique game display, including playing cards or other game information. As indicated above, the machine-readable code may be configured in various manners, such as by having various “modules” of software which are designed to implement specific features of the game play or game presentation. For example, the code or software may include an algorithm which causes the controller (such as by using random numbers generated by the random number generator) to select virtual playing cards and then cause those virtual playing cards to be graphically displayed or “dealt” to for the initial two card Player hand and Banker hand and to form a final Player hand and Banker hand, according to the rules herein (wherein the displayed cards and the like may be stored as graphic image files or the like, such as in the data tables 138). Further, the code or software may include an algorithm which evaluates the outcomes of the wagers, such as by comparing the initial and final Player and Banker hands to the player wagers, based upon the rules of the game (e.g. the outcome of the Baccarat game may be determined by comparing the final Player hand and Banker hand to determine which hand won or if there was a tie, and to then compare that winning outcome to the player's Baccarat wager to determine if it is winning or losing, and to compare the player's bonus hand(s) to the two card Player hand and two card Banker hand as detailed herein to determine if the player has achieved a bonus winning outcome). The code or software may then settle player wagers, such as by collecting those wagers which are losing (e.g. deducting the wagers from the credit balance) or payout winnings for those wagers which are winning (such as by increasing the player's credit balance based upon awarded winnings).

The gaming machine 122 may be configured to generate and present games in a stand-alone manner or it may be in communication with one or more external devices or systems 142 at one or more times. The gaming machine 122 might communicate with one or more of such external devices or systems 42 via one or more communication ports 144 or other interface devices. These ports or interface devices 144 may be configured to implement various communication protocols (including proprietary protocols) and communicate via wireless, wired or other communication link. For example, the gaming machine 122 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 122 is configured to present one or more wagering games. The gaming machines 122 is preferably configured to accept value, such as in the form of coins, tokens, paper currency or other elements or devices representing value such as monetary funds. Thus, as indicated above, the gaming machine 122 preferably includes a mechanism or means for accepting monetary value. For example, the gaming machine 122 might include a coin acceptor for accepting coins. Of course, associated coin reading/verifying devices and coin storage devices may be associated with the gaming machine 122 if it is configured to accept coins Likewise, as illustrated in FIG. 8, the gaming machine 122 might include a media reader 146. Such a reader may be configured to accept and read/verify paper currency and/or other media such as tickets. Of course, in such event the gaming machine 122 may further be configured with one or more paper currency or ticket storage devices, such as cash boxes, and other paper currency or media handling devices (including transport devices).

The gaming machine 122 might also be configured to read FOBs, magnetic stripe cards or other media having data associated therewith and via which value or funds may be associated with the gaming machine 122. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 122 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 122 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 122 dispensing coins to a coin tray. In another embodiment, funds may be issued by dispensing paper currency or other media. In yet another embodiment, a player may be issued a media, such as a printed ticket, which ticket represents the value which was paid or cashed out of the machine. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In this regard, the gaming machine 122 may include one or more media printers or writers 148. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 122 may also include a player tracking device, such as a card reader and/or an associated keypad or other input device (such as a touch screen display). Such player tracking devices may permit the game operator to track play of players of the gaming machine. The tracked play may be utilized to offer player bonuses or awards.

As illustrated in FIG. 9, the main game controller or processor 34 may communicate with several of the peripheral devices via one or more intermediary controllers. For example, some of the peripheral devices might comprise USB type or enabled devices which are controlled by an intermediary USB controller.

A casino may have numerous such gaming machines 122, such as located on a casino floor or in other locations. Of course, such gaming machines 122 might be used in other environments, such as an airport, a bar or tavern or other locations.

It will be appreciated that the gaming machine illustrated in FIGS. 8 and 9 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

The gaming machine 122 may, as noted above, be part of a system which includes other devices. For example, the gaming machine 122 may communicate with one or more casino systems, such as a player tracking server or system, an accounting system or server, a ticketing system, a bonusing system, a tournament system, other gaming machines, and external devices.

The electronic presentation device might also comprise an electronic gaming table which includes one or more video displays which are used to display images of cards (rather than having physical playing cards be dealt at the table). In one embodiment, such a table might have similar features to the gaming machine 122 noted above, except arranged in a table layout, where at least one video display and associated player input devices are associated with individual player positions, as linked to a controller which comprises a table controller.

The invention may have other configurations and features. In one embodiment, while the award for a winning player ROYAL 9® wager may be a progressive jackpot or a portion thereof, other awards could be provided. Such awards may comprise, for example, fixed value jackpots, multipliers or multiples of the player's side wager and the like (and could comprise awards other than monies or chips or credits representative of monies or funds, such as points or the like). Also, other card combinations or the like could be used as the basis for the personalized player Baccarat bonus bet. As noted above, in one embodiment, each player may be assigned three ROYAL 9® personal player card combinations. However, in a preferred embodiment, a player might be assigned one such card combination (such as per the example described below), or two or four or more such combinations. Also, in one embodiment, while personal player card combinations might be assigned to player positions, they might also be assigned or even selected by each player. For example, instead of assigning at least one personal player card combination to each of a number of player positions, players might select such from a menu of combinations (wherein two or more players may not select the same combinations). Also, while in a preferred embodiment the personal player card combinations are ROYAL 9® card combinations, other combinations might be utilized (for example, it may be possible to use other combinations of cards such as a face card and eight card or two cards or the same value or the like).

In this regard, in another embodiment of the invention, each player may be assigned or select a single personal player card combination for the personalized player Baccarat bonus bet. In a preferred embodiment, the card combination comprises a unique ROYAL 9® card combination comprising a King and a nine. As one example, such combinations might be selected from the following group or may be assigned to player positions as indicated below:

| Player position | ROYAL 9 ® card combination |
|---|---|
| 1 | King of Spades/9 of Hearts |
| 2 | King of Spades/9 of Diamonds |
| 3 | King of Clubs/9 of Hearts |
| 4 | King of Clubs/9 of Diamonds |
| 5 | King of Hearts/9 of Spades |
| 6 | King of Hearts/9 of Clubs |
| 7 | King of Diamonds/9 of Spades |
| 8 | King of Diamonds/9 of Clubs |
| 9 | King of Diamonds/9 of Hearts |
| 10 | King of Diamonds/9 of Diamonds |
| 11 | King of Hearts/9 of Diamonds |
| 12 | King of Hearts/9 of Hearts |
| 13 | King of Clubs/9 of Spades |
| 14 | King of Clubs/9 of Clubs |
| 15 | King of Spades/9 of Clubs |
| 16 | King of Spades/9 of Spades |

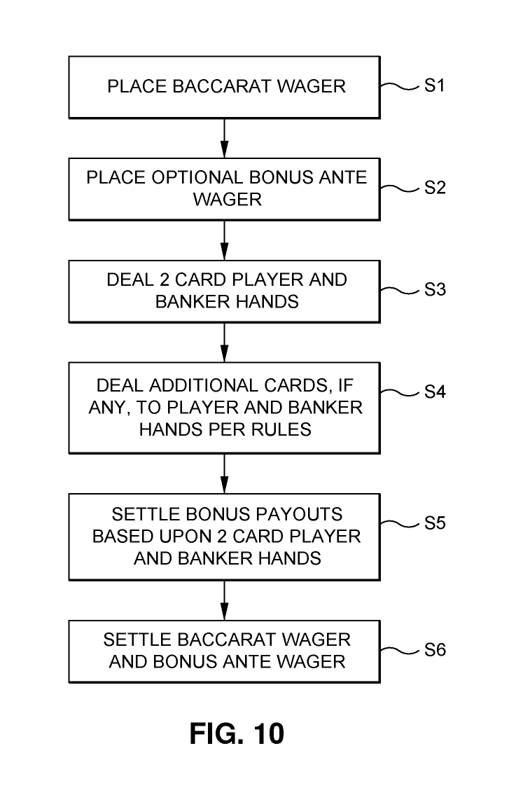

In one embodiment of a method of playing and presenting this embodiment of the game, a base game of Baccarat is again presented. Each player is again required to place a Baccarat wager on either the Player hand, the Banker hand or a Tie. As noted above, such may be effected by the player placing one or more wagering chips at associated wagering areas designated on a table, or via one or more inputs to a wagering device such as a gaming machine, as in a step S1 as illustrated in FIG. 10.

The player may also electe to place a bonus or jackpot wager, as in a step S2. If the player does not place a bonus or jackpot wager, then they are ineligible to participate in the bonus or jackpot portion of the game.

In one embodiment, the Baccarat wager must be equal to or greater than the jackpot or bonus wager, and a jackpot or bonus wager minimum and maximum value may be set.

In one embodiment, the game progresses by presenting a Baccarat game. In one embodiment, a two card Player hand and a two card Banker hand are dealt, as in a step S3. The hands may be dealt from one or more standard decks of playing cards, such as a set of 8 shuffled decks of cards (such as shuffled manually or via one or more devices, such as a mechanical or electro-mechanical card shuffler; and in an electronic implementation, by randomly selecting cards or card sets).

As noted below, a player's jackpot or bonus bet is evaluated relative to the two card Player hand and/or two card Banker hand. However, the player's Baccarat wager is evaluated based upon the final Baccarat hands. In this regard, in accordance with standard Baccarat game rules, one or more additional cards may be dealt to either or both of the Player hand and the Banker hand, such as in a step S4, such as based upon the following:

1) no further cards are dealt to a natural Player hand or natural Banker hand comprising a total of 8 or 9 in the first two cards;

2) Player Hand: if the Player hand has a count of 0-5, a card is drawn; if the Player hand has a count of 6 or 7 the hand stands;

3) Banker Hand: if the Banker hand has a count of 0, 1 or 2, a card is drawn; if the count is 3 a card is drawn except when the Player draws an “8” as the third card; if the count is 4, a card is drawn when the Player's third card is a 2-7; if the count is 5 then a card is drawn when the Player's third card is a 4-7; if the count is 6 then a card is drawn when the Player's third card is a 6 or 7; and if the count is 7, the Banker stands.

In one embodiment, all bonus payouts are settled based upon the two card Player and Banker hands, as in a step S5. In a preferred embodiment, the bonus payouts are settled before the Bacarrat wagers are settled along with any bonus ante wagers, as in a step S6. The term “settle” may mean to evaluate the outcome of a particular wager or event and to then resolve that outcome, such as by collecting the wager or paying winnings.

In one embodiment, a player's Baccarat wager is resolved in a normal fashion. As one example, a Baccarat wager on the Player hand pays 1 to 1 for a win, pushes on a tie, and loses on all other outcomes. A Baccarat wager on the Banker hand might pay 0.95 to 1 for wins (where there is a 5% commission on the Banker hand wager) or may pay 1 to 1 except on winning totals of 7 points with three cards, where the outcome is a push (such as for commission free Baccarat), and otherwise the Banker hand wager may push on a tie and lose on any other outcome. If the game is implemented as a commission free game, then the player may place an optional Banker 7 Bonus wager. This wager wins if the Banker hand finishes with three cards totalling 7 point, and is otherwise lost. In one embodiment, a winning Banker 7 wager is paid 20 to 1 if the Banker hand ties the Player hand, is paid 25 to 1 if it wins against the Player hand, and is paid 50 to 1 if it loses aginst the Player hand. A wager on a Baccarat hand “Tie” may be paid at 8 to 1 and lose on all other outcomes.

If a player has placed a jackpot or bonus wager and they lose their Baccarat wager (loss or a push), then their jackpot or bonus wager loses (and is collected).

If a player has placed a jackpot or bonus wager and they won their Baccarat wager, then their jackpot or bonus wager wins even money (e.g. 1 to 1). In addition, the player may be awarded winnings for their jackpot or bonus wager. In one embodiment, the player can win one of four bonus payouts:

1) A first payout if the player's personal combiantion occurs in the Banker hand or the Player hand. This payout may be referred to as the “Personal King-Nine” payout.

2) A second payout if the player's personal combination occurs in the Banker hand or the Player hand and the other hand consists of a Natural (an 8 or 9 on the first two cards). This payout may be referred to as the “Personal King-Nine vs. Any Natural)” payout.

3) A third payout if the player's personal combination occurs in the Banker hand or the Player hand and the other hand consists of any other King-Nine combination. This payout, may be referred to as the “Personal King-Nine vs. Any King-Nine” payout.

4) A fourth payout if the player's personal combination occurs in both the Banker hand and the Player hand. This payout may be referred to as the “Personal King-Nine on Both Hands” payout.

Set forth below in Table 1 are examples of potential payouts.

TABLE 1

| Winning Result | Pay Table 1 | Pay Table 2 |
|---|---|---|
| Personal King-Nine | 30 | 25 |
| Personal King-Nine vs. Any Natural | 100 | 100 |
| Personal King-Nine vs. Any King-Nine | 250 | 500 |
| Personal King-Nine on Both Hands | 500 | 1000 |

As noted above, in one embodiment, bonus payouts are settled before the dealer settles any of the Bacarrat wagers. The jackpot or bonus wagers may be settled at the same time that the dealer settles the player's Bacarrat wager.

As with the other embodiments of the invention, this embodiment may be presented or implemented at a gaming table using physical playing cards and a unqiue table layout, an electronic table having video display devices which display images of cards, and./or other electronic presentation devices such as electronic gaming machines.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a monetary funds accepting mechanism for accepting monetary funds in creating a player credit balance;
at least one display device;
at least one player input device;
a memory device;
a controller; and
machine-readable code stored in said memory device executable by said controller to receive a Baccarat wager and, optionally, a bonus wager, placed by said player from said player credit balance;
machine-readable code executable by said controller to cause said controller to cause said at least one display device to display a two card Player hand and a two card Banker hand;
machine-readable code executable by said controller to cause said controller to cause said at least one display device to display none or one or more additional cards to form a final Player hand and a final Banker hand based upon one or more Baccarat game rules;
machine-readable code executable by said controller to settle said player's Baccarat wager with reference to said final Player hand and/or said final Banker hand; and
machine-readable code executable by said controller to settle said player's bonus wager with reference to a bonus hand which is unique to said player relative to any other players of said game and said two card Player hand and/or said two card Banker hand.

2. The gaming machine in accordance with claim 1 wherein said player's Baccarat wager comprises an election of a Player hand, a Banker hand or a Tie.

3. The gaming machine in accordance with claim 2 wherein said machine-readable code executable by said controller to settle said player's Baccarat wager comprises code which causes said controller to determine an outcome comprising whether said final Player hand or said final Banker hand is winning, or if there is a tie, and comparing said player's election to said outcome, wherein said player's wager is winning if the player's election matches said outcome.

3. The gaming machine in accordance with claim 1 wherein said bonus hand comprises a single Royal 9 hand comprising a King and a 9 card of one or more suits.

4. The gaming machine in accordance with claim 1 wherein said machine-readable code executable by said controller to settle said player's bonus wager comprises code which causes said controller to award winnings to said player:
a) when said two card Banker hand or two card Player hand comprises said player's bonus hand;
b) when said two card Banker hand or said two card Player hand comprises said player's bonus hand and the other hand comprises of a Baccarat natural hand;
c) when said two card Banker hand or said two card Player hand comprises the player's bonus hand and the other hand comprises any other King-9 combination; and
d) when said two card Banker hand and said two card Player hand comprises the player's bonus hand.

5. The gaming machine in accordance with claim 4 wherein said code causes said controller to:
a) award first winnings to said player when said two card Banker hand or two card Player hand comprises said player's bonus hand;
b) award second winnings to said player when said two card Banker hand or said two card Player hand comprises said player's bonus hand and the other hand comprises of a Baccarat natural hand;
c) award third winnings to said player when said two card Banker hand or said two card Player hand comprises the player's bonus hand and the other hand comprises any other King-9 combination; and
d) award fourth winnings to said player when said two card Banker hand and said two card Player hand comprises the player's bonus hand.

6. The gaming machine in accordance with claim 5 wherein said first winnings comprise 30× said player's bonus wager, said second winnings comprise 100× said player's bonus wager, said third winnings comprise 250× said player's bonus wager, and said fourth winnings comprise 500× said player's bonus wager.

7. The gaming machine in accordance with claim 5 wherein said first winnings comprise 25× said player's bonus wager, said second winnings comprise 100× said player's bonus wager, said third winnings comprise 500× said player's bonus wager, and said fourth winnings comprise 1000× said player's bonus wager.

8. The gaming machine in accordance with claim 1 wherein said gaming machine presents a multi-player game and each player has a unique bonus hand.

9. The gaming machine in accordance with claim 8 wherein each bonus hand comprises a single unique King-9 card combination of one or more suits.

10. A method of presenting a Baccarat game with a bonus opportunity to a plurality of players at a gaming table comprising the steps of:
receiving, relative to each of said plurality of players, a Baccarat wager comprising at least one physical item associated with a monetary value at either a Player hand wagering location, a Banker hand wagering location or a Tie wagering location of a layout of said gaming table;
receiving, relative to each of said plurality of players, an optional bonus wager comprising at least one physical item associated with a monetary value at a bonus wagering location of said layout of said gaming table;
associating a single unique bonus hand with each of said plurality of players;
dealing onto said layout of said gaming table, from at least one deck of 52 physical playing cards, a two card Player hand and a two card Banker hand;
dealing, none, one or more additional cards from said at least one deck onto said layout to form a final Player hand and a final Banker hand;
determining a winning outcome of said Baccarat game comprising said final Player hand, said final Banker hand or a Tie;
paying winnings to each of said plurality of players who placed a Baccarat wager on said winning outcome of said Baccarat game;
relative to each player who placed a bonus wager, determining an outcome of said bonus wager by comparing said unique bonus hand with at least one of said two card Player and said two card Banker hand; and
paying winnings to each player who placed a winning bonus wager.

11. The method in accordance with claim 10 comprising determining a player's bonus wager to be winning:
a) when said two card Banker hand or two card Player hand comprises said player's bonus hand;
b) when said two card Banker hand or said two card Player hand comprises said player's bonus hand and the other hand comprises of a Baccarat natural hand;
c) when said two card Banker hand or said two card Player hand comprises the player's bonus hand and the other hand comprises any other King-9 combination; and
d) when said two card Banker hand and said two card Player hand comprises the player's bonus hand.

12. The method in accordance with claim 11 wherein said step of paying winnings comprises:
a) paying first winnings to said player when said two card Banker hand or two card Player hand comprises said player's bonus hand;
b) paying second winnings to said player when said two card Banker hand or said two card Player hand comprises said player's bonus hand and the other hand comprises of a Baccarat natural hand;
c) paying third winnings to said player when said two card Banker hand or said two card Player hand comprises the player's bonus hand and the other hand comprises any other King-9 combination; and
d) paying fourth winnings to said player when said two card Banker hand and said two card Player hand comprises the player's bonus hand.

13. The method in accordance with claim 12 wherein said first winnings comprise 30× said player's bonus wager, said second winnings comprise 100× said player's bonus wager, said third winnings comprise 250× said player's bonus wager, and said fourth winnings comprise 500× said player's bonus wager.

14. The method in accordance with claim 12 wherein said first winnings comprise 25× said player's bonus wager, said second winnings comprise 100× said player's bonus wager, said third winnings comprise 500× said player's bonus wager, and said fourth winnings comprise 1000× said player's bonus wager.
